(19) United States
(12) Patent Application Publication
(10) Pub. No.: US 2026/0330012 A1
(43) Pub. Date: Oct. 22, 2026

(54) INTELLIGENT MACHINE ASSISTANT FOR DEVELOPERS TO GENERATE THREAT MITIGATION AND ADHERE TO COMPLIANCE

(71) Applicant: Dell Products L.P., Round Rock, TX (US)

(72) Inventors: Vivek Bhargava, Bangalore (IN); Abhishek Mishra, Bangalore (IN); Jegadesh Bogaraj, Periyakulam (IN); Sneha A. Jain, Bangalore (IN)

(21) Appl. No.: 19/182,236

(22) Filed: Apr. 17, 2025

(51) Int. Cl. G06F 21/55

(52) U.S. Cl. CPC G06F 21/554; G06F 2221/033

(57) ABSTRACT

A method for securing a target application includes obtaining, from a Large Language Model (LLM)-based threat extraction repository and for the target application, a likelihood rating associated with a new threat and an impact rating associated with the new threat. The method also includes calculating, using the likelihood rating and the impact rating, a risk score of the new threat. Further, the method includes generating, based on at least the risk score, a set of mitigation measures. Moreover, the method includes initiating modification of the target application based on the set of mitigation measures in order to secure the target application.

### BACKGROUND

Thorough security assessments are essential to secure applications. However, current software threat models that perform security assessments often lead to redundancy and inconsistency in threat reporting, hindering the efficiency and effectiveness of these models.

### BRIEF DESCRIPTION OF DRAWINGS

Certain embodiments of the disclosure will be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a diagram of a threat intelligence system in accordance with one or more embodiments.

FIG. 3 shows a flowchart of a method for obtaining a probabilistic classifier in accordance with one or more embodiments.

FIG. 4 shows a flowchart of a method for obtaining a new threat in accordance with one or more embodiments.

FIG. 5 shows a flowchart of a method for securing a target application in accordance with one or more embodiments.

FIG. 6 shows a computing system in accordance with one or more embodiments.

### DETAILED DESCRIPTION

The purpose of software threat modeling is to reduce potential security risks to application. Security is a crucial aspect of any system, as new and old threats surface frequently and unexpectantly. Therefore, thorough security assessments are essential to safeguard applications.

However, traditional approaches to threat modeling are time-consuming, prone to human error, and difficult to scale. Specifically, a current approach is to simply list and provide threats to individual developers of the organization to implement mitigation strategies. As a result, inconsistencies and challenges in maintaining compliance ensues. These shortcomings create uncertainty about the organization's security posture. Further, the outcomes of threat modeling are highly dependent on the adopted process and expertise of the developers, who need to be continually updated on security measures. This dependence can result in missing critical aspects, leaving applications vulnerable and non-compliant. Moreover, in current approaches to threat modeling, threats identified for components used across multiple applications are often reported repeatedly. This creates duplicative efforts and inefficiencies, leaving room for improvement in the threat model. Further, the high level of manual intervention increases the likelihood of overlooking certain aspects.

Moreover, security teams may provide generic mitigation measures and unclear justifications that are not tailored to the specific use case of the threat within the application or organization, leading to inefficiencies and potential security gaps. Generic mitigation measures are created by relying on predefined threat categories, which can result in false positives or missed critical vulnerabilities, such as man-in-the-middle attacks. Unclear justifications fail to demonstrate the actual mitigation implemented. This lack of clarity hinders effective evaluation during the follow-up phase, thereby not ensuring that the correct code has been injected to resolve the issue. Traditional approaches like this often lack clear mitigation strategies and justifications, leaving development teams uncertain about addressing identified threats effectively. For example, consider a scenario in which a mobile application that provides executives with real-time sales data is a high-risk target for unauthorized access and data manipulation. During the threat modeling process, traditional approaches may retrieve the following generic description:
“Web/Mobile Applications may be able to impersonate the context of API Gateway—B2C Internal to gain additional privileges”

Continuing with the scenario and due to this generic description, a development team of the organization administering the mobile application mistakenly classified the issue as an infrastructure problem. As a result, the team marked it as “Not Applicable-no scope of additional privileges” for their mitigation comment, indicating that the lack of specificity in the threat description led to confusion among the developers.

The limitations of the traditional approaches to software threat modeling restrict the usability of mitigating threats in real-world applications. For at least the reasons discussed above, a fundamentally different approach is needed to address these challenges and improve the efficiency of software threat modeling. Embodiments herein relate to a method for securing a target application. As a result of the processes discussed below, one or more embodiments disclosed herein introduces a threat intelligence system that analyzes and mitigates the risk of threats within application infrastructure and system behavior using machine learning (ML) and artificial intelligence (AI). By leveraging AI and ML technology, resolving old and new threats can be streamlined, reducing the burden on the security team and increasing efficiency in threat review. Embodiments disclosed herein aim to discover threats and vulnerabilities early so that the development team can be assisted with mitigation steps and resolutions. This approach minimizes manual effort at the organizational level and introduces effective intelligence to address security threats. Further, embodiments disclosed herein automatically generate comprehensive vulnerability reports, ensuring up-to-date security insights without manual intervention. These reports provide detailed information on vulnerabilities, including their impacts, risk scores, and mitigation strategies. These features offer significant advancements over existing methods, providing more dynamic, accurate, and automated solutions for software threat modeling and risk management. Additionally, embodiments disclosed herein offer significant advancements over existing methods for threat detection and vulnerability reporting.

Specific embodiments will now be described with reference to the accompanying figures.

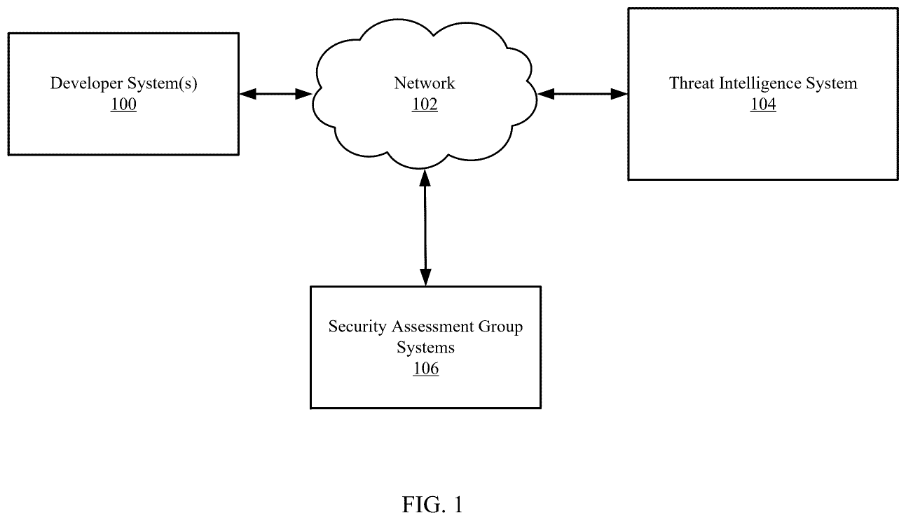

FIG. 1 shows a system in accordance with one or more embodiments of the invention. The system may include any number of developer systems (100), a network (102), a threat intelligence system (104), and a security assessment group systems (106). The system may include additional, fewer, and/or different components without departing from the scope disclosed herein. Each component may be operably/operatively connected to any of the other components via any combination of wired and/or wireless connections. Each of these system components is described below.

In one or more embodiments, the developer system(s) (100) and the threat intelligence system (104) are operatively connected to one another through a network (102). The network (102) may be implemented using any combination of wired and/or wireless connections. Further, the network (102) may encompass various interconnected, network-enabled subcomponents (or systems) (e.g., switches, routers, gateways, etc.) that may facilitate communications between the developer system(s) (100) and the threat intelligence system (104). Moreover, the developer system(s) (100) and the threat intelligence system (104) may communicate with one another using any combination of wired and/or wireless communication protocols.

In one or more embodiments, the developer system(s) (100) and the security assessment group systems (106) are also operatively connected to one another through the network (106). The network (102) may facilitate communications between the developer system(s) (100) and the security assessment group systems (106). The developer system(s) (100) and the security assessment group systems (106) may communicate with one another using any combination of wired and/or wireless communication protocols.

In one or more embodiments, the developer system(s) (100) includes functionality to interact with the threat intelligence system (104) and the security assessment group systems (106). Further, in one or more embodiments, the developer system(s) (100) includes functionality to receive a set of mitigation measures from the security assessment group systems (106). In one or more embodiments, the developer system(s) (100) modify a target application using the set of mitigation measures in order to secure the target application. One of ordinary skill will appreciate that the developer system(s) (100) may perform other functionalities without departing from the scope disclosed herein.

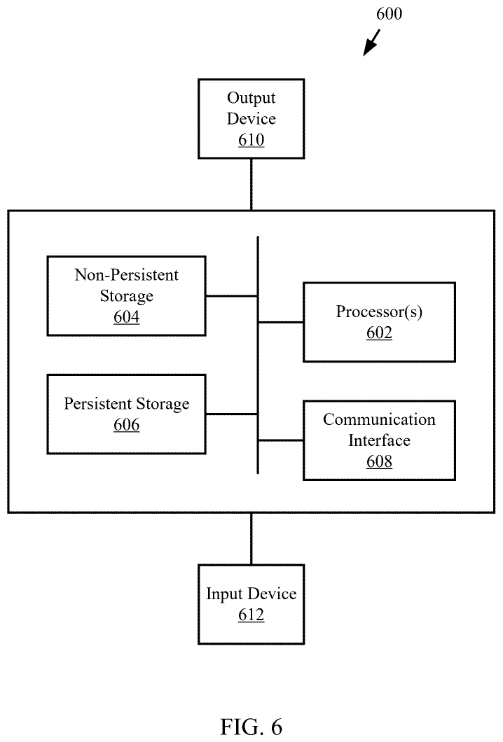

In one or more embodiments disclosed herein, the developer system(s) (100) may be a physical device. In one or more embodiments, the developer system(s) (100) may also be a virtual device (i.e., a virtual machine executing on one or more physical devices) such as a personal computing system (e.g., a laptop, a cell phone, a tablet computer, a virtual machine executing on a server, etc.) of a user. For example, the developer system(s) (100) may be a computing system (e.g., 600, FIG. 6) as discussed below in more detail in FIG. 6.

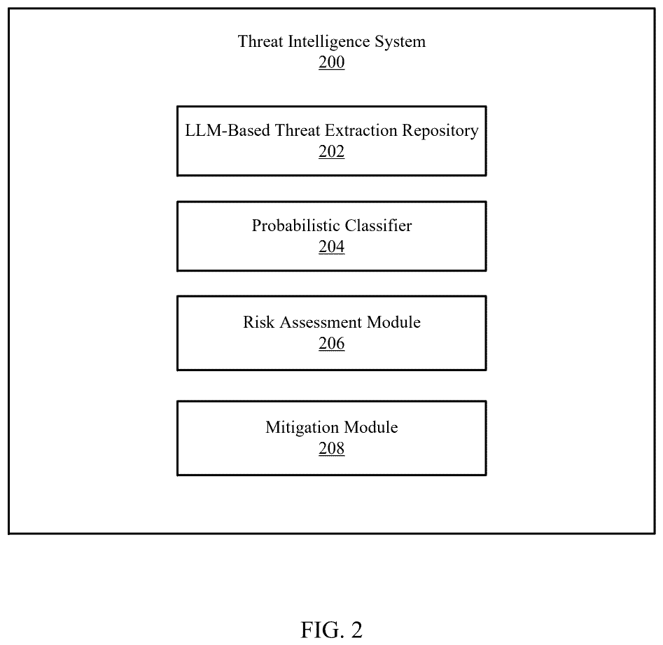

In one or more embodiments, the threat intelligence system (104) includes functionality to utilize information retrieved from an application, or a system's architectural components, to automatically identify all the relevant and applicable threats to each component. In one or more embodiments, the threat intelligence system (104) also gathers the associated security requirements, test cases, threat agents, code review guidelines and code snippets to provide all the necessary information needed for prioritizing threat mitigation efforts. To assist in identifying the threats, the threat intelligence system (104) utilizes a probabilistic classifier algorithm which, after trained on the appropriate datasets, classifies new instances of threats based on prior probability and likelihood learned from the training datasets. Unlike traditional approaches to software threat modeling, the threat intelligence system (104) utilizes AI and ML technology to provide the most efficient and effective process for identifying valid threats and minimizing false positives. By translating potential security risks into specific, actionable controls for software development and security teams, the threat intelligence system (104) will alert qualified individuals newly discovered threats promptly. This process allows for timely intervention and reducing the accumulation of risks. In one or more embodiments, the threat intelligence system (104) includes functionality to perform at least a portion of the methods shown in FIGS. 2-5. One of ordinary skill will appreciate that the threat intelligence system (104) may perform other functionalities without departing from the scope disclosed herein.

In one or more embodiments, the threat intelligence system (104) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the threat intelligence system (104) may be implemented on a computing system (e.g., 600, FIG. 6) as discussed below in more detail in FIG. 6.

In one or more embodiments, the security assessment group systems (106) includes functionality to interact with the threat intelligence system (104) and the developer system(s) (100). In one or more embodiments, the security assessment group systems (106) retrieves the set of mitigation measures generated by the threat intelligence system (104) and provides the set of mitigation measures to the developer system(s) (100). One of ordinary skill will appreciate that the security assessment group systems (106) may perform other functionalities without departing from the scope disclosed herein.

In one or more embodiments disclosed herein, the security assessment group systems (106) may be a physical device. In one or more embodiments, the security assessment group systems (106) may also be a virtual device (i.e., a virtual machine executing on one or more physical devices) such as a personal computing system (e.g., a laptop, a cell phone, a tablet computer, a virtual machine executing on a server, etc.) of a user. For example, the security assessment group systems (106) may be a computing system (e.g., 600, FIG. 6) as discussed below in more detail in FIG. 6.

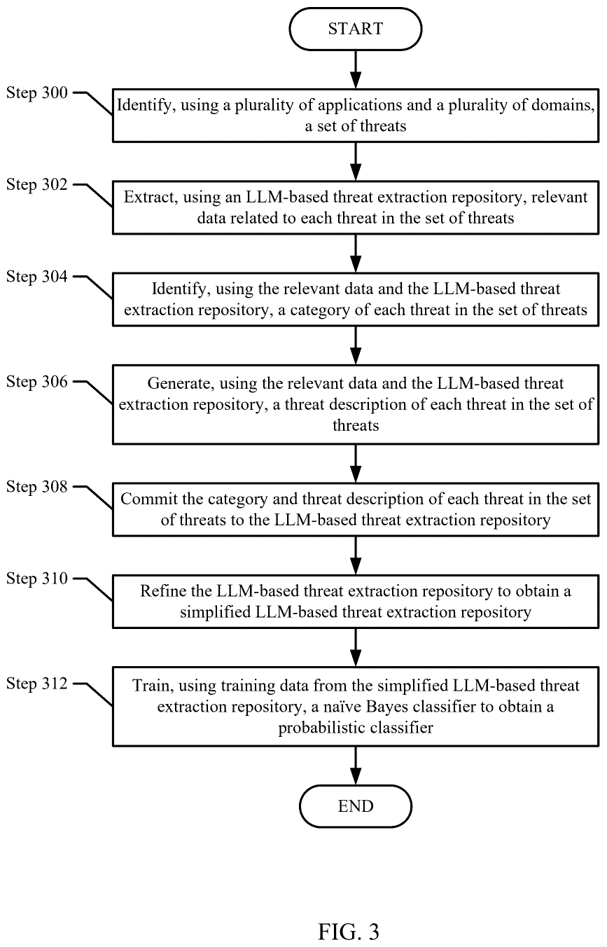

Turning to FIG. 2, FIG. 2 shows a threat intelligence system (200) in accordance with one or more embodiments of the invention. The threat intelligence system (200) includes a Large Language Model (LLM)-based threat extraction repository (202), a probabilistic classifier (204), a risk assessment module (206), and a mitigation module (208). The threat intelligence system (200) and the components therein may be used to perform all or a portion of the methods described in FIGS. 3-5. Each of these components is described below.

In one or more embodiments, the LLM-based threat extraction repository (202) includes functionality to scan the contents of threats raised from multiple applications and different domains. In one or more embodiments, the LLM-based threat extraction repository (202) also includes functionality to extract relevant data related to non-standard diagnostics, troubleshooting, and mitigation failure recommendations on threat actions. In one or more embodiments, the LLM-based threat extraction repository (202) can be refined to obtain a simplified LLM-based threat extraction repository. In one or more embodiments, the simplified LLM-based threat extraction repository provides the threat content in language optimized for clarity and ease of understanding, enhancing user comprehension. One of ordinary skill will appreciate that the LLM-based threat extraction repository (202) may perform other functionalities without departing from the scope disclosed herein.

In one or more embodiments, the LLM-based threat extraction repository (202) may be hosted on any type of non-volatile (or persistent) storage, including, for example, a hard disk drive, NAND Flash memory, NOR Flash memory, Magnetic RAM Memory (M-RAM), Spin Torque Magnetic RAM Memory (ST-MRAM), Phase Change Memory (PCM), or any other memory defined as a non-volatile Storage Class Memory (SCM), a redundant array of independent disks (RAID), network attached storage (NAS), cloud storage, etc. In one or more embodiments, the LLM-based threat extraction repository (202) may be implemented using any format suitable for the storage of the corresponding entries in this repository. The repository may be, for example, a collection of text or binary files, spreadsheets, SQL databases etc. or any other type of hierarchical, relational and/or object-oriented collection of data.

In one or more embodiments, the probabilistic classifier (204) includes functionality to calculate the probability of occurrence of each relevant threat in different categories. In one or more embodiments, the probabilistic classifier (204) is obtained by training a naïve Bayes classifier on a training dataset focused specifically on threats and their corresponding mitigation strategies. Once the training data is fed into the classifier, the classifier classifies each threat into a threat class, and learns the prior probability and likelihood of each threat class. The prior probability is the probability of a certain class occurring in the data, and the likelihood of is the probability of a certain feature given a class. In one or more embodiments, the probabilistic classifier (204) includes functionality to calculate the probability of each threat class for a new instance of data, where the threat class with the highest probability will be the predicted threat category. One of ordinary skill will appreciate that the probabilistic classifier (204) may perform other functionalities without departing from the scope disclosed herein.

In one or more embodiments, the risk assessment module (206) includes functionality to calculate the risk of each threat by weighing its potential impact and the likelihood of it occurring. By utilizing ML technology, the risk assessment module (206) can determine a likelihood rating and an impact rating of the threat. In one or more embodiments, a high likelihood rating corresponds to a high probability of occurrence. Alternatively a low likelihood rating corresponds to a low probability of occurrence. Similarly, a high impact rating corresponds to a high impact (which is typically a negative impact from a security perspective) if the threat materializes. Alternatively, a low impact rating corresponds to a low impact (which is typically a negative impact from a security perspective) if the threat materializes. In one or more embodiments, the risk assessment module (206) calculates the risk score of a threat by multiplying the likelihood rating and the impact rating of the threat. Based on the risk score, the threat may be categorized having a low, moderate or high level of risk associated with the threat. One of ordinary skill will appreciate that the risk assessment module (206) may perform other functionalities without departing from the scope disclosed herein.

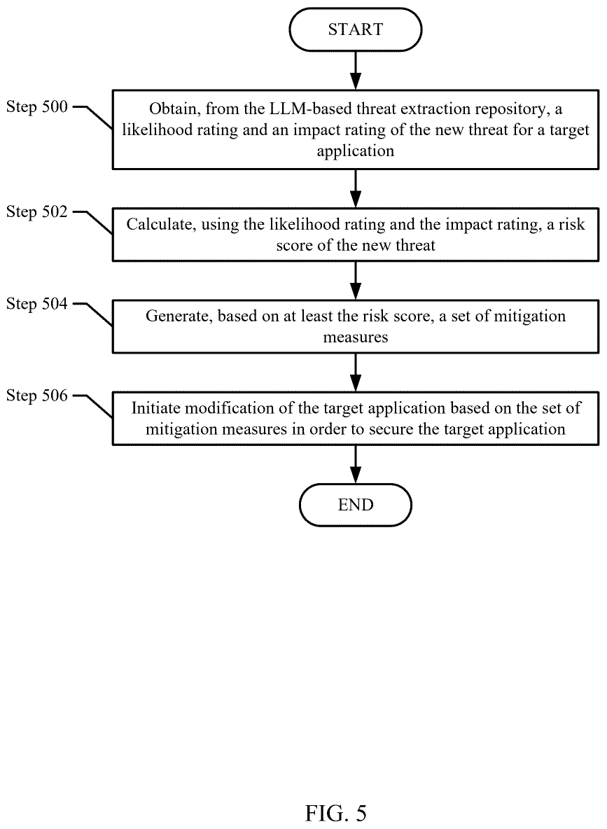

In one or more embodiments, the mitigation module (208) generates mitigation measures to respond to the threat based on its associated risk score and, as discussed in FIG. 5, initiates the application and/or performance of the mitigation measures. In one or more embodiments, the mitigation module (208) identifies common countermeasures and implements well known standards, such as Open Web Application Security Project (OWASP) and Common Weakness Enumeration (CWE) to generate the mitigation measures. In one or more embodiments, countermeasures refer to actions, strategies, or controls implemented to mitigate or neutralize identified risks, threats, vulnerabilities, or attacks within an organization or application. They are proactive measures designed to prevent, detect, and respond to security incidents effectively. The countermeasures also include options that security teams can take if the measures are not implemented in time. In one or more embodiments, the mitigation module (208) collects metadata based on context and domain specific information from all the different sources listed above to generate mitigation measures. In one or more embodiments, the mitigation module (208) also implements secure coding notes and compliant code snippets built in an organization that contains a summary about the threat to generate mitigation measures. Further, in one or more embodiments, the mitigation module (208) generates, as part of the initiation of the application of the mitigation measures, a summary report comprising conceptual and technical details to respond to the threat and secure the application or organization. As discussed below in FIG. 5, the mitigation module initiates the application of mitigation measures on the target application. One of ordinary skill will appreciate that the mitigation module (208) may perform other functionalities without departing from the scope disclosed herein.

Turning to FIG. 3, FIG. 3 shows a flowchart of a method for obtaining a probabilistic classifier in accordance with one or more embodiments. The method may be performed by, for example, the threat intelligence system (104, FIG. 1). Other components in the system may perform this method without departing from the scope disclosed herein.

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, a set of threats is identified using a plurality of applications and a plurality of domains. In one or more embodiments, the LLM-based threat extraction repository (202, FIG. 2) identifies and scans the contents of threats raised from a variety of applications and different domains to build a threat dataset, which includes the set of threats.

In step 302, relevant data related to each threat in the set of threats is extracted using an LLM-based threat extraction repository (202, FIG. 2). In one or more embodiments, relevant data includes data related to non-standard diagnostics, troubleshooting, and recommendations for failed mitigation measures taken on a specific threat.

In step 304, a category of each threat in the set of threats is identified using the relevant data and the LLM-based threat extraction repository (202, FIG. 2). As a non-limiting example, a category of a threat may be “Tampering”.

In step 306, a threat description of each threat in the set of threats is generated using at least the relevant data and the LLM-based threat extraction repository (202, FIG. 2). Continuing with the non-limiting example, a threat description of a threat in the category “Tampering” is “Malicious script injected into a webpage”.

In step 308, the category and threat description of each threat in the set of threats is committed to the LLM-based threat extraction repository (202, FIG. 2).

In step 310, the LLM-based threat extraction repository (202, FIG. 2) is refined to obtain a simplified LLM-based threat extraction repository. In one or more embodiments, the threat content in the LLM-based threat extraction repository (202, FIG. 2) is refined to provide the content of the repository in simplified language for a user to understand.

For example, continuing with the example above, the threat content may be:

```
{
  “threats”: {
    “component”: “Web Application”,
    “url”: “http://example.com”,
    “port”: 443,
    “severity”: “medium”,
    “threat category”: “Tampering”,
    “description”: “ Malicious script injected into a webpage.”
  }
}
```

Continuing with the example above, the threat content, once refined, may be:

```
{
  “doc”: {
    “domain”: “Web Application”,
    “url”: “http://example.com/”,
    “port”: 443,
    “sources”: {
      “type”: “WEB”,
      “name”: “Cross-Site Scripting (XSS)”,
      “attributes”: {
        “cvss_score”: 7.8,
        “cve”: [
          {
            “id”: “CVE-2022-12345”,
            “description”: “Injection of malicious scripts into vulnerable web applications.”
          }
        ],
        “severity”: “medium”,
        “target_platforms”: [
          “Windows”,
          “Linux”
        ],
        “fp”: {
          “alarm”: “false”,
          “descr”: “”
        }
      }
    },
    “procedures”: “1. Identify endpoints susceptible to tampering\n2. Modify parameters or data
without proper authorization\n3. Observe changes and verify unauthorized modifications”,
    “threat”: [
      “Data Tampering”
    ],
    “impact”: {
      “initial_privilege”: “user”,
      “final_privilege”: “user”, // Typically, but can escalate depending on application logic
      “capabilities_gained”: [
        “data_theft”,
        “session_hijacking”
      ]
    },
    “threat category”: “Tampering”,
    “tags”: [
      “Tampering”,
      “Web Application”,
      “XSS”
    ],
    “ttps”: [
      {
        “id”: “T1565”,
        “name”: “ Injection ”,
        “description”: “ Inject malicious script into web page ”
      }
    ],
    “iocs”: [
      {
        “type”: “URL”,
        “value”: “ http://malicious-website.com/xss-script.js ”
      }
    ]
  }
```

Continuing the discussion of FIG. 3, in step 312, a naïve Bayes classifier is trained using training data from the simplified LLM-based threat extraction repository to obtain a probabilistic classifier (204, FIG. 2). In one or more embodiments, the probabilistic classifier (204, FIG. 2) is constructed by training a naïve Bayes classifier on a dataset specifically centered on threats and their corresponding mitigation strategies. During the training, the classifier assigns each threat to a threat class and learns both the prior probabilities and the likelihoods associated with each class.

The method may end following step 312.

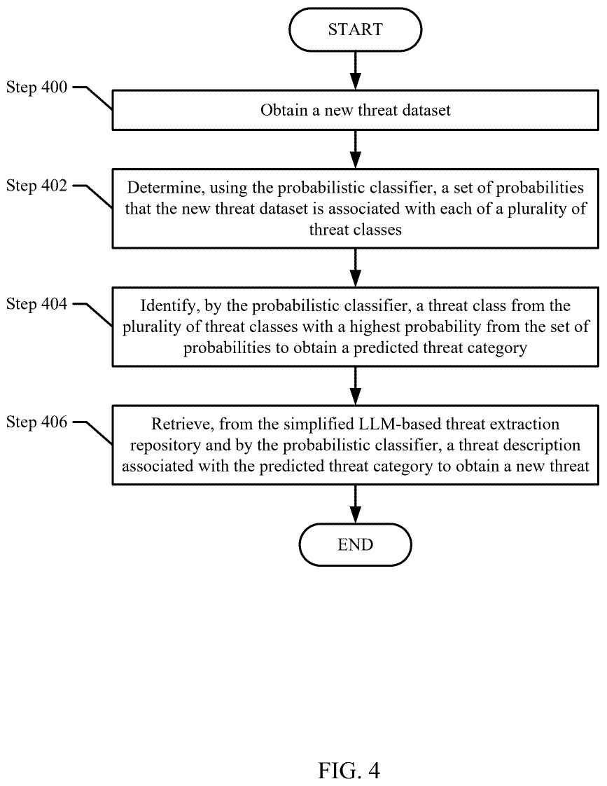

Turning to FIG. 4, FIG. 4 shows a flowchart of a method for obtaining a new threat in accordance with one or more embodiments. The method may be performed by, for example, the threat intelligence system (104, FIG. 1). Other components in the system may perform this method without departing from the scope disclosed herein.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 400, a new threat dataset is obtained. The new threat dataset includes new threats that are seen, e.g., by the organization and/or by the IT security community more broadly. In one or more embodiments, the new threat dataset is stored the LLM-based threat extraction repository (202, FIG. 2).

In step 402, a set of probabilities that the new threat dataset is associated with each of a plurality of threat classes is determined using the probabilistic classifier (204, FIG. 2). In one or more embodiments, the plurality of threat classes comprises “Tampering” and “Cross-Site Scripting (XSS)”.

In step 404, a threat class from the plurality of threat classes with a highest probability from the set of probabilities is identified by the probabilistic classifier (204, FIG. 2) to obtain a predicted threat category. In one or more embodiments, the predicted threat category is the category most likely to occur in an organization or application based on the new threat dataset.

In step 406, a threat description associated with the predicted threat category is retrieved from the LLM-based threat extraction repository (202, FIG. 2) to obtain a new threat. In one or more embodiments, the threat description is retrieved by the probabilistic classifier (204, FIG. 2).

The method may end following step 406.

Turning to FIG. 5, FIG. 5 shows a flowchart of a method for securing a target application in accordance with one or more embodiments. The method may be performed by, for example, the threat intelligence system (104, FIG. 1). Other components in the system may perform this method without departing from the scope disclosed herein.

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 500, a likelihood rating and an impact rating of the new threat for the target application are obtained from the LLM-based threat extraction repository (202, FIG. 2). In one or more embodiments, the likelihood rating and the impact rating are received by the risk assessment module (206, FIG. 2). The target application corresponds to the application for which a security assessment/review is being performed.

In step 502, a risk score of the new threat is calculated using the likelihood rating and the impact rating. In one or more embodiments, the risk score is calculated by the risk assessment module (206, FIG. 2). In one or more embodiments, the risk assessment module (206, FIG. 2) calculates the risk score of a threat by multiplying the likelihood rating and the impact rating of the threat. As a non-limiting example, the likelihood rating of the new threat “XSS leading to database compromise” for the target application is 4 (medium probability of occurrence) and the impact rating of the new threat for the target application is 3 (moderate impact if the threat materializes). To calculate the risk score of the new threat, the likelihood rating and the impact rating are multiplied. In this non-limiting example, the resulting risk score is 12, indicating a moderate level of risk associated with the threat.

In step 504, a set of mitigation measures are generated based on at least the risk score. In one or more embodiments, mitigation measures are generated using standards such as OWASP and CWE. Further, mitigation measures are also generated using common countermeasures associated with the threat.

In step 506, modification of the target application is initiated, based on the set of mitigation measures, in order to secure the target application. In one or more embodiments, modification of the target application includes initiating the automated generation of code, through AI and ML technologies, in order to generate and/or modify the source code of the target application based on the mitigation measures. In one or more embodiments, initiating of modification of the target application includes generating, by the mitigation module (208, FIG. 2), a summary report. In one or more embodiments, the summary report comprises an overview of the report, the identified vulnerability, the impact assessment, the risk score, and the set of mitigation measures. The summary report is subsequently provided to a qualified developer. The qualified developer is a developer most likely to implement the mitigation measures in the security report efficiently to successfully respond to the new threat in order to secure the application or organization.

As a non-limiting example, in a summary report for “Mitigation Cross Site Scripting (XSS) for Database Security”, the overview is “This report outlines steps taken to prevent XSS vulnerabilities in our web applications, aimed at protecting against potential database compromise”. The identified vulnerability is “XSS vulnerabilities were identified in web application components, exposing potential risks of session hijacking and database access”. Continuing with this example, the impact assessment is “Potential compromise of user sessions and unauthorized access to sensitive database information”. Moreover, the risk score is “moderate risk level”. Further, the summary report includes key actions to take to secure the threat (i.e., the set of mitigation measures). The key actions are “implement rigorous input validation and output encoding to block malicious scripts, add Content Security Policy (CSP) to restrict content sources and mitigate XSS attack vectors, and enable Web Application Firewall (WAF) to monitor and filter HTTP traffic for XSS payload”.

The method may end following step 510.

Embodiments of the disclosure may be implemented using computing devices. FIG. 6 shows a diagram of a computing device (600) in accordance with one or more embodiments. The computing device (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (608) (e.g., Bluetooth interface, infrared interface, network interface, optical interface, etc.), input devices (612), output devices (610), and numerous other elements (not shown) and functionalities. Each of these components is described below.

In one embodiment, the computer processor(s) (602) may be an integrated circuit for processing instructions. For example, the computer processor(s) (602) may be one or more cores or micro-cores of a processor. The computing device (600) may also include one or more input devices (612), such as a touchscreen, keyboard, mouse, microphone, touchpad, electronic pen, or any other type of input device. The communication interface (508) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment, the computing device (600) may include one or more output devices (610), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (612, 610) may be locally or remotely connected to the computer processor(s) (602), nonpersistent storage (604), and persistent storage (606). Many diverse types of computing devices exist, and the aforementioned input and output device(s) (612, 610) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the prior description of the figures, any component described with regard to a figure, in various embodiments of the invention, may be equivalent to one or more likenamed components described with regard to any other figure. For brevity, descriptions of these components are not repeated with regard to each figure. Thus, each and every embodiment of the components of each figure is incorporated by reference and assumed to be optionally present within every other figure have one or more like-named components. Additionally, in accordance with various embodiment of the invention, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for securing a target application, the method comprising:
obtaining, from a Large Language Model (LLM)-based threat extraction repository and for the target application, a likelihood rating associated with a new threat and an impact rating associated with the new threat;
calculating, using the likelihood rating and the impact rating, a risk score of the new threat for the target application;
generating, based on at least the risk score, a set of mitigation measures for the target application; and
initiating modification of the target application based on the set of mitigation measures in order to secure the target application.

2. The method of claim 1, wherein initiating modification of the target application comprises providing a summary report to a qualified developer.

3. The method of claim 1, the method further comprising:
prior to obtaining, from the LLM-based threat extraction repository, the likelihood rating associated with the new threat and the impact rating associated with the new threat for the target application:
obtaining, from the LLM-based threat extraction repository, a new threat dataset;
determining, using a probabilistic classifier, a set of probabilities that the new threat dataset is associated with each of a plurality of threat classes;
identifying, by the probabilistic classifier, a threat class from the plurality of threat classes with a highest probability from the set of probabilities to obtain a predicted threat category;
retrieving, from the LLM-based threat extraction repository, a threat description associated with the predicted threat category; and
obtaining, from the threat description, the new threat.

4. The method of claim 3, the method further comprising:
prior to obtaining, from the LLM-based threat extraction repository, the new threat dataset:
identifying, using a plurality of applications and a plurality of domains, a set of threats;
extracting, using the LLM-based threat extraction repository, relevant data related to each threat in the set of threats;
identifying, using the relevant data and the LLM-based threat extraction repository, a category of each threat in the set of threats;
generating, using the relevant data and the LLM-based threat extraction repository, a threat description of each threat in the set of threats; and
committing the category and threat description of each threat in the set of threats to the LLM-based threat extraction repository.

5. The method of claim 4, further comprising:
refining the LLM-based threat extraction repository obtain a simplified LLM-based threat extraction repository.

6. The method of claim 4, the method further comprising:
after committing the category and the threat description of each threat in the set of threats to the LLM-based threat extraction repository:
training, using training data from the LLM-based threat extraction repository, a naïve Bayes classifier to obtain the probabilistic classifier.

7. The method of claim 1, wherein the risk score is calculated by multiplying the likelihood rating associated with the new threat and the impact rating associated with the new threat.

8. A non-transitory computer readable medium (CRM) comprising computer readable program code, which when executed by a computer processor, enables the computer to perform a method for securing a target application, the method comprising:
obtaining, from an LLM-based threat extraction repository and for the target application, a likelihood rating associated with a new threat and an impact rating associated with the new threat;
calculating, using the likelihood rating and the impact rating, a risk score of the new threat for the target application;
generating, based on at least the risk score, a set of mitigation measures for the target application;
initiating modification of the target application based on the set of mitigation measures in order to secure the target application.

9. The non-transitory CRM of claim 8, wherein initiating modification of the target application comprises providing a summary report to a qualified developer.

10. The non-transitory CRM of claim 8, the method further comprising:
prior to obtaining, from the LLM-based threat extraction repository, the likelihood rating associated with the new threat and the impact rating associated with the new threat for the target application:
obtaining, from the LLM-based threat extraction repository, a new threat dataset;
determining, using a probabilistic classifier, a set of probabilities that the new threat dataset is associated with each of a plurality of threat classes;
identifying, by the probabilistic classifier, a threat class from the plurality of threat classes with a highest probability from the set of probabilities to obtain a predicted threat category;
retrieving, from the LLM-based threat extraction repository, a threat description associated with the predicted threat category; and
obtaining, from the threat description, the new threat.

11. The non-transitory CRM of claim 10, the method further comprising:
prior to obtaining, from the LLM-based threat extraction repository, the new threat dataset:
identifying, using a plurality of applications and a plurality of domains, a set of threats;
extracting, using the LLM-based threat extraction repository, relevant data related to each threat in the set of threats;
identifying, using the relevant data and the LLM-based threat extraction repository, a category of each threat in the set of threats;
generating, using the relevant data and the LLM-based threat extraction repository, a threat description of each threat in the set of threats; and
committing the category and threat description of each threat in the set of threats to the LLM-based threat extraction repository.

12. The non-transitory CRM of claim 11, further comprising:
refining the LLM-based threat extraction repository obtain a simplified LLM-based threat extraction repository.

13. The non-transitory CRM of claim 11, the method further comprising:
after committing the category and the threat description of each threat in the set of threats to the LLM-based threat extraction repository:
training, using training data from the LLM-based threat extraction repository, a naïve Bayes classifier to obtain the probabilistic classifier.

14. The non-transitory CRM of claim 8, wherein the risk score is calculated by multiplying the likelihood rating associated with the new threat and the impact rating associated with the new threat.

15. A threat intelligence system, comprising:
a processor; and
memory comprising instructions, which when executed by the processor, performs a method for securing a target application, the method comprising:
obtaining, from an LLM-based threat extraction repository and for the target application, a likelihood rating associated with a new threat and an impact rating associated with the new threat;
calculating, using the likelihood rating and the impact rating, a risk score of the new threat for the target application;
generating, based on at least the risk score, a set of mitigation measures for the target application;
initiating modification of the target application based on the set of mitigation measures in order to secure the target application.

16. The threat intelligence system of claim 15, wherein initiating modification of the target application comprises providing a summary report to a qualified developer.

17. The threat intelligence system of claim 15, the method further comprising:
prior to obtaining, from the LLM-based threat extraction repository, the likelihood rating associated with the new threat and the impact rating associated with the new threat for the target application:
obtaining, from the LLM-based threat extraction repository, a new threat dataset;
determining, using a probabilistic classifier, a set of probabilities that the new threat dataset is associated with each of a plurality of threat classes;
identifying, by the probabilistic classifier, a threat class from the plurality of threat classes with a highest probability from the set of probabilities to obtain a predicted threat category;
retrieving, from the LLM-based threat extraction repository, a threat description associated with the predicted threat category; and
obtaining, from the threat description, the new threat.

18. The threat intelligence system of claim 17, the method further comprising:
prior to obtaining, from the LLM-based threat extraction repository, the new threat dataset:
identifying, using a plurality of applications and a plurality of domains, a set of threats;
extracting, using an LLM-based threat extraction repository, relevant data related to each threat in the set of threats;
identifying, using the relevant data and the LLM-based threat extraction repository, a category of each threat in the set of threats;
generating, using the relevant data and the LLM-based threat extraction repository, a threat description of each threat in the set of threats; and
committing the category and threat description of each threat in the set of threats to the LLM-based threat extraction repository.

19. The threat intelligence system of claim 18, the method further comprising:
after committing the category and threat description of each threat in the set of threats to the LLM-based threat extraction repository:
training, using training data from the LLM-based threat extraction repository, a naïve Bayes classifier to obtain the probabilistic classifier.

20. The threat intelligence system of claim 15, wherein the risk score is calculated by multiplying the likelihood rating associated with the new threat and the impact rating associated with the new threat.
